(19) United States
(12) Patent Application Publication
(10) Pub. No.: US 2023/0076224 A1
(43) Pub. Date: Mar. 9, 2023

(54) VEHICLE BODY FOR TWO-WHEELED VEHICLE, TWO-WHEELED VEHICLE, AND SHOCK ABSORBER FOR SAME

(71) Applicants: Ji Young PARK, Gunpo-si, Gyeonggi-do (KR); Jong Woo PARK, Gunpo-si, Gyeonggi-do (KR)

(72) Inventors: Ji Young PARK, Gunpo-si, Gyeonggi-do (KR); Jong Woo PARK, Gunpo-si, Gyeonggi-do (KR)

(21) Appl. No.: 17/798,247

(22) PCT Filed: Mar. 9, 2021
(86) PCT No.: PCT/KR2021/002934

§ 371 Date: Aug. 8, 2022

(30) Foreign Application Priority Data
Mar. 11, 2020 (KR) 10-2020-0030051

(51) Int. Cl. B62K 3/04

(52) U.S. Cl. CPC B62K 3/04; B62K 2201/04; B62K 2201/02; B62K 2201/08

(57) ABSTRACT

The present invention relates to a vehicle body for a two-wheeled vehicle, the vehicle body having excellent shock-absorbing performance and enabling structure simplification since both a front wheel frame and a rear wheel frame can rotate with respect to a saddle frame so that shock is absorbed at both a front wheel and a rear wheel, even if shock is applied to either the front wheel or the rear wheel. The vehicle body for a two-wheeled vehicle comprises: a rotary frame comprising a saddle frame having a saddle mounted on the top thereof, a front wheel frame connected to a front wheel shaft, and a rear wheel frame connected to a rear wheel shaft, which are rotatably coupled to each other through a rotary support part; and a shock absorber which is provided between the saddle frame, the front wheel frame and the rear wheel frame, and which elastically supports, with respect to the saddle frame, the front wheel frame and the rear wheel frame that rotate upward toward the saddle frame around the rotary support part.

### TECHNICAL FIELD

The present invention relates to a vehicle body for a two-wheeled vehicle such as a bicycle or a motorcycle, a two-wheeled vehicle, and a shock absorber for the same.

### BACKGROUND ART

When a two-wheeled vehicle such as a bicycle or motorcycle travels along a road surface, corrugations on the road surface apply shocks to wheels. A shock-absorbing device is installed between wheels and a frame to prevent direct transfer of impacts applied to the wheels to a saddle installed on the frame.

In general, a shock-absorbing device is installed between a frame on which a saddle and a handle are installed, and forks installed on both sides of a front-wheel shaft such that shocks applied to the front wheel is damped and transferred to the handle and the saddle. In this case, a pair of shock-absorbing devices are necessary. Forks having shock-absorbing devices installed in this manner are commonly referred to as suspension forks. It is also possible to install a single shock-absorbing device between a handle shaft and a fork shaft installed on parts which are installed on both sides of the front-wheel shaft, and which are combined into one above wheels.

If a shock-absorbing device is installed only on the front wheel, all shocks applied to the rear wheel are delivered to the occupant through the saddle, and the occupant does not feel comfortable during riding.

Korean Patent Publication No. 10-2008-0012098, entitled SHOCK-ABSORBING DEVICE FOR TWO-WHEELED VEHICLE (inventor: CHOI, YongJip), discloses another example for damping shocks applied to the rear wheel, wherein one side of a frame connected to the rear wheel and one side of another frame on which a saddle is installed are connected by a joint hinge link, and a shock-absorbing device is installed between the two frames. This invention by CHOI has a problem in that all shocks applied to the front wheel are transferred to the frame on which the saddle is installed. In order to solve this problem, an additional shock-absorbing device needs to be installed between the frame on which the saddle is installed and the front wheel.

That is, conventional two-wheeled vehicles commonly need 2-3 shock-absorbing devices to damp all shocks applied to front and rear wheels. Shock-absorbing devices are not only expensive, but also have a problem in that two-wheeled vehicle manufacturing processes become complicated because various components of the shock-absorbing devices need to be installed together.

There is another problem in that conventional vehicle bodies for two-wheeled vehicles have complicated structures and assembling processes and high manufacturing costs because shock absorbers need to be separately installed at various locations.

### DISCLOSURE OF INVENTION

### Technical Problem

An object of the present invention is to provide a vehicle body for a two-wheeled vehicle, the structure and assembling process of which can be simplified, thereby lowering the manufacturing cost of the two-wheeled body.

Another object of the present invention is to provide a vehicle body for a two-wheeled vehicle wherein shocks applied to front and rear wheels can be damped by a single shock absorber and then transferred to the saddle.

Another object of the present invention is to provide a vehicle body for a two-wheeled vehicle wherein shock absorbers can be gathered and installed at a single location, thereby simplifying manufacturing processes.

Still another object of the present invention is to provide a two-wheeled vehicle, the vehicle body structure and assembling process of which are not complicated, and which are configured such that all shocks applied to front and rear wheels are damped by a minimum shock absorber then transferred to the saddle.

Yet another object of the present invention is to provide a shock absorber which can be appropriately used for a vehicle body for a two-wheeled vehicle of the present invention.

### Solution to Problem

A vehicle body for a two-wheeled vehicle, installed between a front wheel shaft of a front wheel and a rear wheel shaft of a rear wheel, according to the present invention includes: a rotary frame including a saddle frame having an upper end on which a saddle is mounted, a front wheel frame connected to the front wheel shaft, and a rear wheel frame connected to the rear wheel shaft, which are rotatably coupled to each other through a rotary support part; and a shock absorber installed between the saddle frame, the front wheel frame, and the rear wheel frame, and configured to elastically support the front wheel frame and the rear wheel frame, which upwardly rotate toward the saddle frame around the rotary support part, with respect to the saddle frame, whereby the single shock absorber is configured to be able to absorb all the shocks applied to the front wheel and the rear wheel.

The saddle frame may have a load support part having an upper end provided with a saddle mounting part on which the saddle is mounted, and a lower end coupled to the rotary support part and a first front extension part extending forward between the upper and lower ends of the load support part to be coupled to a protrusion or a handle shaft installed on a handle, the front wheel frame may extend forward from the rotary support part to be inclined upward so as to be coupled to a fork shaft of a fork installed on the front wheel shaft, and the rear wheel frame may be provided with a rotary connection part extending rearward from the rotary support part to be connected to the rear wheel shaft, and a second front extension part extending forward from the rotary connection part to be inclined upward, wherein the handle shaft, which is prohibited from moving up and down and is supported to be rotatable left and right with respect to the first front extension part, may be connected to the fork shaft such that the fork shaft is not allowed to rotate left and right and is allowed to move up and down around the rotary support part, and the shock absorber may be installed between the first front extension part, the second front extension part, and the front wheel frame.

The shock absorber may include a shock-absorbing device installed on the second front extension part to face forward, and a foldable link connected to the front end of the shock-absorbing device and connected to the first front extension part and the front wheel frame, respectively, to be bent rearward so as to be unfolded or folded according to the magnitude of a force acting on the shock-absorbing device, thereby performing elastic support between the first front extension part and the front wheel frame.

The shock-absorbing device may be rotatably installed on the second front extension part.

The shock-absorbing device may be connected to the second front extension part or the foldable link through a bolt and a nut to adjust a degree of compression of the shock-absorbing device, thereby adjusting the magnitude of an elastic force for supporting the foldable link.

In some cases, the shock absorber may include a shock-absorbing device installed on the second front extension part to face forward, and a foldable link connected to the front end of the shock-absorbing device and connected to the first front extension part and the front wheel frame, respectively, to be bent rearward so as to be unfolded or folded according to the magnitude of a force acting on the shock-absorbing device, thereby performing elastic support between the first front extension part and the front wheel frame, wherein the shock-absorbing device may include a telescopic bolt coupled to be stretchable and having threads formed on the outer circumferential surfaces of both ends thereof, at least one pair of nuts coupled to the threads on the outer circumferential surfaces of the both ends, respectively, and a spring coupled to the outer circumferential surfaces of the telescopic bolt between the pair of nuts, the spring having a degree of compression adjustable according to the rotational direction of the at least one nut.

The rotary support part may include a driving shaft, the front wheel frame, the rear wheel frame, and the saddle frame are connected to be rotatable with respect to the driving shaft, and the driving shaft may be rotatably driven by one of pedals, a prime mover, and a motor.

The shock absorber may include a rubber elastic body installed between the first front extension part, the front wheel frame, and the second front extension part.

The shock absorber may include one of a coil spring, a rubber elastic body, a hydraulic cylinder mechanism, and a pneumatic cylinder mechanism.

A shock absorber according to the present invention includes: a shock-absorbing device; and a foldable link connected to one end of the shock-absorbing device, wherein the foldable link is unfolded or folded according to the magnitude of an elastic force received from the shock-absorbing device due to a force applied to the shock-absorbing device from a first member connected to the other end of the shock-absorbing device, thereby performing elastic support between a second member and a third member which are rotatably connected to both ends of the foldable link, respectively.

The shock-absorbing device may include a telescopic bolt coupled to be stretchable and having threads formed on the outer circumferential surfaces of both ends thereof, at least one pair of nuts coupled to the threads on the outer circumferential surfaces of the both ends, respectively, and a spring coupled to the outer circumferential surfaces of the telescopic bolt between the pair of nuts, the spring having a degree of compression adjustable according to the rotational direction of the at least one nut.

A two-wheeled vehicle according to the present invention includes: a front wheel; a rear wheel; and the vehicle body for a two-wheeled vehicle, according to the present invention, installed between a front wheel shaft of the front wheel and a rear wheel shaft of the rear wheel.

### Advantageous Effects of Invention

According to the present invention, the structure of a vehicle body for a two-wheeled vehicle can be simplified, and shocks applied from both front and rear wheels to a saddle frame can be damped.

According to the present invention, all shocks transferred from both front and rear wheels to the saddle can be damped by a single shock absorber.

According to the present invention, shock absorbers can be concentrated and installed at a single location, thereby simplifying manufacturing processes.

According to the present invention, both a front-wheel frame and a rear-wheel frame can rotate with regard to a saddle frame such that, even if shocks are successively applied to front and rear wheels, damping actions occur in both front and rear wheels. As such, damping performance is excellent, and the wheels are forced against the ground without bouncing.

### BRIEF DESCRIPTION OF DRAWINGS

FIG. 1 is a side view illustrating an example of a two-wheeled vehicle using a vehicle body for a two-wheeled vehicle according to the present invention,

FIG. 2 is a front view showing that a saddle frame is fixed to a handle shaft and a front wheel frame is connected to a fork shaft,

FIG. 3 is a partially enlarged perspective view illustrating a state in which a saddle frame, a front wheel frame, and a rear wheel frame of a two-wheeled vehicle of FIG. 1 are connected to each other,

FIG. 4a is a partially enlarged plan sectional cross-view illustrating a state in which a handle shaft and a fork shaft are connected to each other, taken along line I-I of FIG. 2,

FIG. 4b is a partially enlarged longitudinal cross-sectional view, taken along line J-J of FIG. 4a,

FIG. 5 is a partially enlarged longitudinal cross-sectional view showing a modified example of FIG. 4b,

FIG. 6 is a front view illustrating another example of a state in which a saddle frame and a front wheel frame are connected to a handle shaft,

FIGS. 7 to 9 are side views respectively illustrating other modified examples of a two-wheeled vehicle according to the present invention,

FIG. 10 is a side view illustrating another example of a two-wheeled vehicle according to the present invention, and

FIG. 11 illustrates a modified example of a shock absorber illustrated in FIG. 1.

100: Two-wheeled vehicle 110: Front wheel

112: Front wheel shaft 114: Fork

114a: Fork shaft 114b: Hole

116: Handle shaft 116a: Groove

117: Handle 120: Rear wheel

122: Rear wheel shaft 130: Vehicle body for two-wheeled vehicle

130a: Rotary frame 131: Saddle frame

131a: Load support part 131b: First front extension part

141: Front wheel frame 151: Rear wheel frame

151a: Rotary connection part 151b: Second front extension part

160: Saddle 162: Rotary support part

170: Shock absorber 171: Shock-absorbing device

171a: Rubber elastic body 173: Foldable link

B: Bolt N: Nut

P: Pin

### BEST MODE FOR CARRYING OUT THE INVENTION

Hereinafter, preferred embodiments of the present invention will be described in detail with reference to the accompanying drawings.

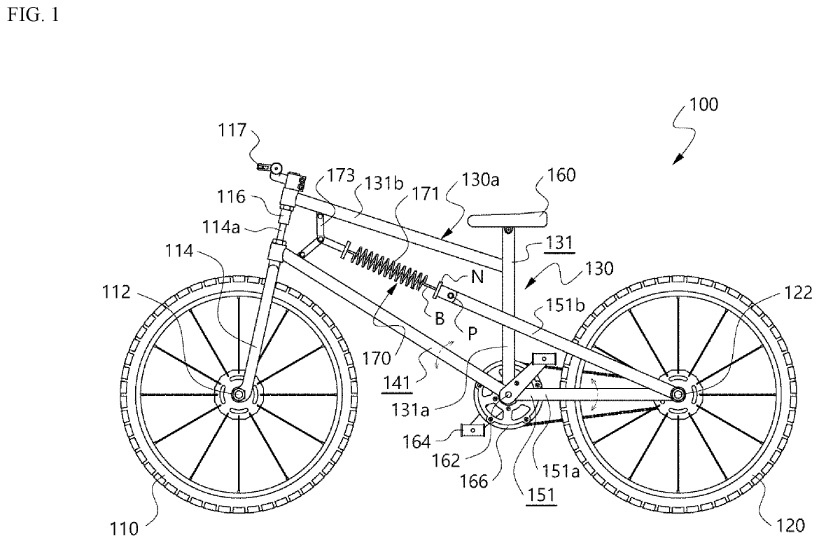

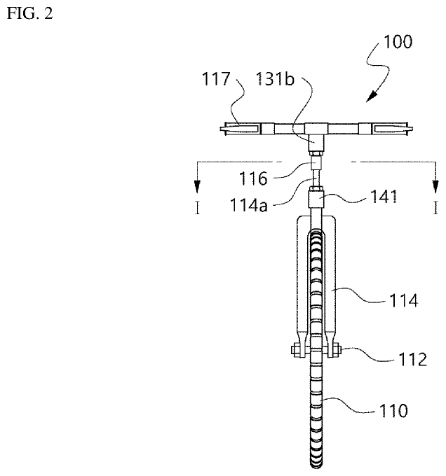

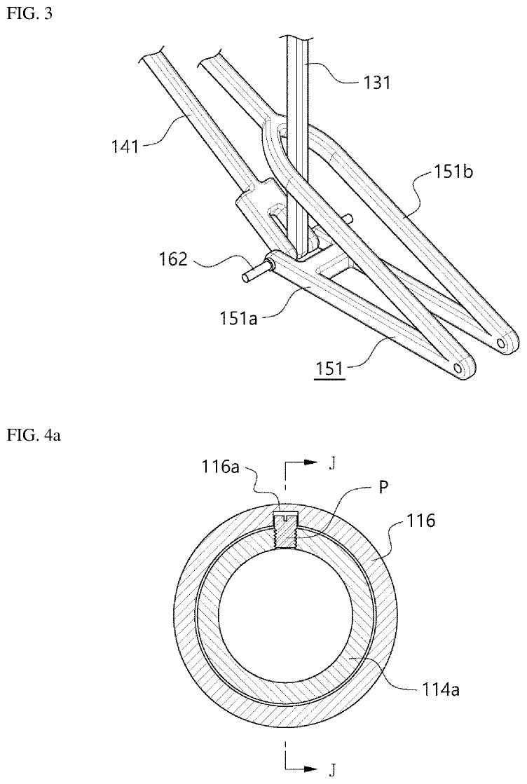

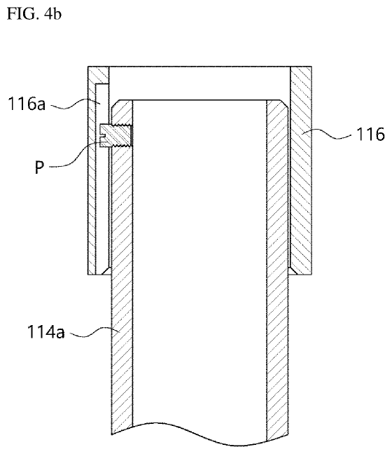

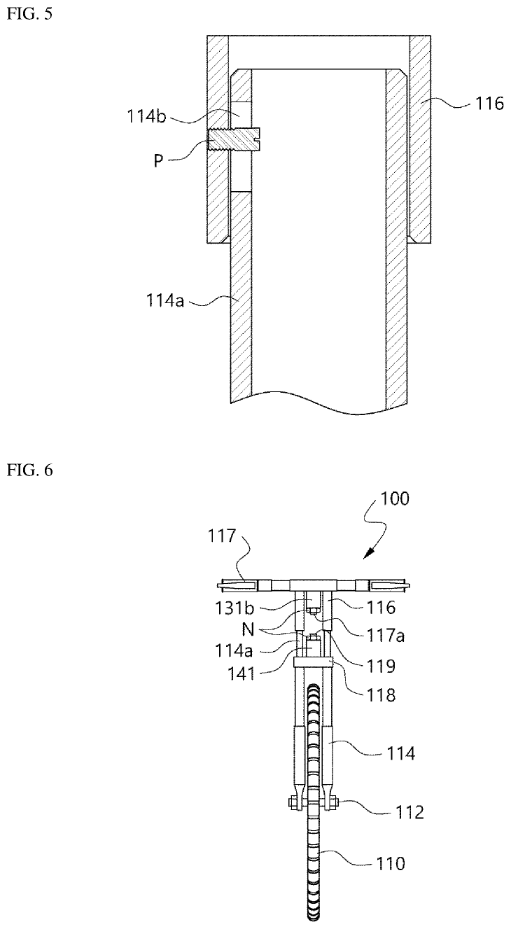

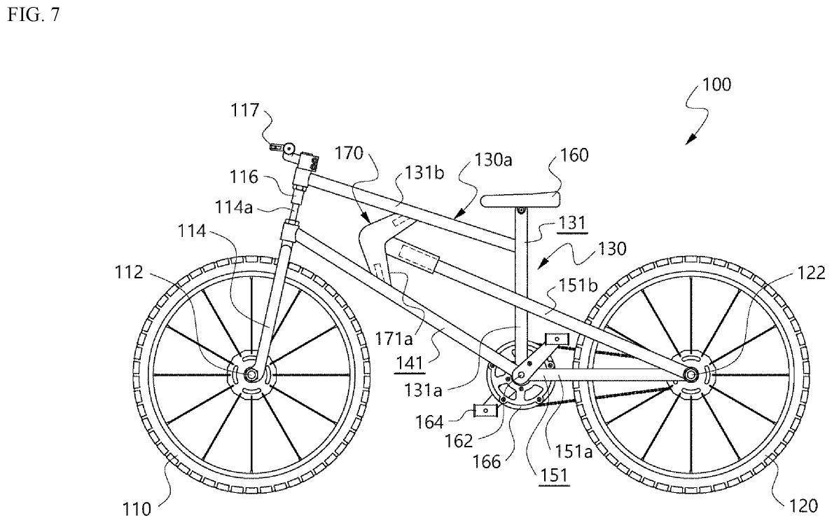

FIG. 1 is a side view illustrating an example of a two-wheeled vehicle using a vehicle body for a two-wheeled vehicle according to the present invention, FIG. 2 is a front view showing that a saddle frame is fixed to a handle shaft and a front wheel frame is connected to a fork shaft, FIG. 3 is a partially enlarged perspective view illustrating a state in which a saddle frame, a front wheel frame, and a rear wheel frame of a two-wheeled vehicle are connected to each other, FIG. 4a is a partially enlarged plan sectional cross-view illustrating a state in which a handle shaft and a fork shaft are connected to each other, taken along line I-I of FIG. 2, FIG. 4b is a partially enlarged longitudinal cross-sectional view, taken along line J-J of FIG. 4a, and FIG. 5 is a partially enlarged longitudinal cross-sectional view showing a modified example of FIG. 4b.

Referring to FIGS. 1 to 5, a two-wheeled vehicle 100 according to the present invention includes a front wheel 110, a rear wheel 120, and a vehicle body 130 for a two-wheeled vehicle installed between a front wheel shaft 112 of the front wheel 110 and a rear wheel shaft 122 of the rear wheel 120 and supported by the front wheel shaft 112 and the rear wheel shaft 122. Forks 114 are supported at both sides of the front wheel 110 by the front wheel shaft 112 and extend upward to merge with each other at the upper end thereof. A fork shaft 114a is provided on the upper end of the merged forks 114, and a handle 117 is installed on the upper end of a handle shaft 116 connected to the fork shaft 114a.

The handle shaft 116 is connected to the fork shaft 114a in a structure in which the fork shaft 114a connected to a front wheel frame 141 is not allowed to rotate left and right with respect to the handle shaft 116 and is allowed to move up and down around a rotary support part 162 to be described later. For example, as shown in FIGS. 4a and 4b, a long groove 116a may be formed in the inner portion of the handle shaft 116 and a pin (P) may be installed in the fork shaft 114a. To allow the fork shaft 114a to move up and down around the rotary support part 162 with respect to the handle shaft 116, as shown in FIGS. 4a, 4b, and 5, it is preferable that a gap is provided between the fork shaft 114a and the handle shaft 116 for smooth vertical rotation therebetween. In addition, a coupling portion between the fork shaft 114a and the handle shaft 116 is preferably formed to be bent by using a distance from the coupling portion to the rotary support part 162 as the radius of curvature. This is also the case in other embodiments.

In some cases, the coupling structure of the handle shaft 116 and the fork shaft 114a may be modified as shown in FIG. 5. As shown, a long groove or hole 114b may be formed in the fork shaft 114a, and a pin (P) may be installed in the handle shaft 116. In this structure, the handle shaft 116 does not allow the fork shaft 114a to rotate left and right with respect to the handle shaft 116 and allows the fork shaft 114a to move up and down around the rotary support part 162. The pin (P) and groove 116a or hole 114b may be installed at positions switched to each other. The groove 116a may be replaced with a hole, and the hole 114b may be replaced with a groove. If the structure of the handle shaft 116 does not allow the fork shaft 114a to rotate left and right while allowing the fork shaft 114a to move up and down, the handle shaft 116 and the fork shaft 114a may be connected using other elements, such as a key and a key groove, instead of the pin (P) and groove 116a or hole 114b.

As noted from FIGS. 1 and 3, the vehicle body 130 for a two-wheeled vehicle has a rotary frame 130a including a saddle frame 131 on which a saddle 160 is mounted on the upper end thereof, a front wheel frame 141 connected to the front wheel shaft 112 through the fork 114, and a rear wheel frame 151 connected to the rear wheel shaft 122 which are coupled to be rotate with each other, and a shock absorber 170 installed between the saddle frame 131, the front wheel frame 141, and the rear wheel frame 151. The shock absorber 170 serves to elastically support the front wheel frame 141 and the rear wheel frame 151 that upwardly rotate toward the saddle frame 131 around the rotary support part 162.

The saddle frame 131 has a load support part 131a having the upper end on which the saddle 160 is mounted and the lower end rotatably coupled to the rotary support part 162, and a first front extension part 131b installed to extend forward from the load support part 131a. The first front extension part 131b is configured to extend forward between the upper and lower ends of the load support part 131a. Preferably, the front end of the first front extension part 131b at which a cylindrical coupling part is formed is coupled to the handle shaft 116. The handle shaft 116, which is prohibited from moving up and down and supported to be rotatable left and right with respect to the first front extension part 131b, is coupled to the fork shaft 114a. As described with reference to FIGS. 4a, 4b, and 5, the handle shaft 116 does not allow the fork shaft 114a to rotate left and right with respect thereto and allows the fork shaft 114a to move up and down around the rotary support part 162.

The front wheel frame 141 extends forward to be inclined upward while being rotatably installed on the rotary support part 162. A gap between the front wheel frame 141 and the first front extension part 131b is gradually becomes narrower in the forward direction thereof. Preferably, the front end of the front wheel frame 141 at which a cylindrical coupling part is formed is coupled to the fork shaft 114a of the upper end of the fork 114 and is supported by the front wheel shaft 112. The front wheel frame 141 allows the fork shaft 114a to rotate left and right, and preferably does not allow the fork shaft 114a to move up and down.

The rear wheel frame 151 is provided with a rotary connection part 151a extending rearward to be supported by the rear wheel shaft 122 while being rotatably installed on the rotary support part 162, and a second front extension part 151b extending forward from the rotary connection part 151a to be inclined upward.

That is, in the present invention, the saddle frame 131, the front wheel frame 141, and the rear wheel frame 151 are connected to rotate with respect to each other through the rotary support part 162. This is one of the great features of the present invention.

Preferably, the rotary support part 162 may be a driving shaft that is rotatably driven by a pedal 164. In some cases, the driving shaft may be rotatably driven by a prime mover or motor. The rotational power of the driving shaft is usually transmitted to the rear wheel 120 through a power transmission means 166 using a chain or the like.

As shown, the shock absorber 170 is installed between the saddle frame 131, the front wheel frame 141, and the rear wheel frame 151 to enable the saddle frame 131, the front wheel frame 141, and the rear wheel frame 151 to be elastically supported with respect to each other. The shock absorber 170 enables the front wheel frame 141, the rear wheel frame 151, and the saddle frame 131 to be elastically supported with respect to each other in a direction opposite to a direction in which the front wheel frame 141 and the rear wheel frame 151 upwardly rotate toward the saddle frame 131 around the rotary support part 162.

This embodiment shows that the saddle frame 131, the front wheel frame 141, and the rear wheel frame 151 are elastically supported with respect to each other by one shock absorber 170. As shown, the shock absorber 170 includes a shock-absorbing device 171 installed on the second front extension part 151b of the rear wheel frame 151 to face forward, and a foldable link 173 installed at the front end of the shock-absorbing device 171.

A coil spring may be used as the shock-absorbing device 171. A pneumatic cylinder mechanism or a hydraulic cylinder mechanism may be used instead of the coil spring. In some cases, a rubber elastic body may also be used as the shock-absorbing device 171. The shock-absorbing device 171 is preferably installed to the rear wheel frame 151 through a pin (P) or the like so as to be rotatable in the vertical direction. In addition, the shock-absorbing device 171 is preferably connected to the second front extension part 151b through a bolt (B) and a nut (N) to adjust the length of the shock-absorbing device 171 between the foldable link 173 and the second front extension part 151b so as to adjust a degree of compression of the shock-absorbing device 171, thereby adjusting the height of the rotary support part 162 and the magnitude of the elastic force for support. When the shock-absorbing device 171 is a coil spring, the bolt (B) may directly form a thread at the end of a wire material forming the coil spring. The nut (N) may be installed to be rotatable in place at the second front extension part 151b, and may allow the bolt (B) to enter or protrude from the inside of the second front extension part 151b according to the rotational direction thereof. Accordingly, the magnitude of the elastic force of the shock-absorbing device 171 and the height of the rotary support part 162 may be adjusted by fastening or loosening the nut (N).

The foldable link 173 includes two link members connected to rotate with respect to each other. The foldable link 173 is bent rearward while being installed at one end of the shock-absorbing device 171, that is, is rotatably connected to the first front extension part 131b and the front wheel frame 141 while being bent toward the shock-absorbing device 171, to be unfolded or folded according to the magnitude of force acting on the shock-absorbing device 171 so as to perform elastic support between the first front extension part 131b and the front wheel frame 141.

The foldable link 173 may also be connected to one end of the shock-absorbing device 171 through the bolt (B) and the nut (N). Through this configuration, the shock-absorbing device 171 connected to the second front extension part 151b through the other end thereof may adjust the magnitude of the elastic force supporting the foldable link 173 and the height of the rotary support part 162 from both sides thereof.

The shock absorber 170 of this embodiment may be applied to other structures other than the vehicle body 130 for a two-wheeled vehicle, which are necessary to perform elastic support between three members by one shock absorber. In this case, a member corresponding to the second front extension part 151b may be referred to as a first member, a member corresponding to the first front extension part 131b may be referred to as second member, and a member corresponding to the front wheel frame 141 may be referred to as a third member.

The two-wheeled vehicle 100 according to the present invention as described above may buffer the shock force applied from both the front wheel 110 and the rear wheel 120 with only one shock absorber 170. In addition, both the front wheel frame 141 and the rear wheel frame 151 may rotate relative to each other not only with respect to the saddle frame 131 but also between the front wheel frame 141 and the rear wheel frame 151 while being elastically supported by each other. Thus, even when a shock is applied to either one of the front wheel 110 and the rear wheel 120 or a shock is continuously applied, the shock absorber 170 absorbs the shock while interacting with all of the front wheel frame 141, the rear wheel frame 151, and the saddle frame 131, and accordingly, the shock-absorbing performance thereof is excellent.

### MODE FOR CARRYING OUT THE INVENTION

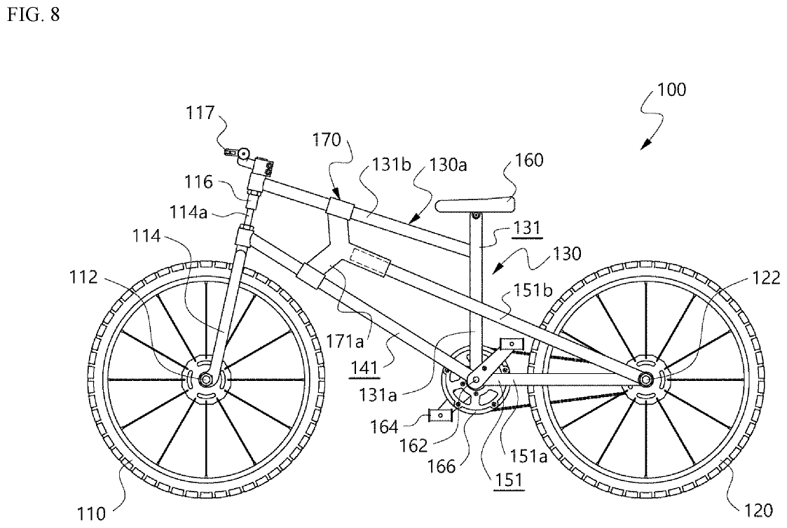

FIG. 6 is a front view illustrating another example of a state in which a saddle frame and a front wheel frame are connected to a handle shaft.

As shown in FIG. 6, fork shafts 114a may be installed on each of the forks 114, respectively, installed on both sides of the front wheel shaft 112, and two handle shafts 116 may be installed on the handle 117, so that the handle shafts 116 are connected to the fork shafts 114a, respectively. The handle shafts 116 and the fork shafts 114a may be connected as described in FIGS. 4a, 4b, and 5.

In this case, protrusions 119 and 117a may be installed on the upper surface of a connection part 118 for connecting the forks 114 at both sides and the lower surface of the handle 117 to connect the front wheel frame 141 and the first front extension part 131b, respectively.

In this case, a thread may be formed on each protrusion 119 or 117a and the nut (N) may be screw-coupled to each protrusion 119 or 117a so that the front wheel frame 141 and the first front extension part 131b are fixed to be prevented from being separated from the protrusions 119 and 117a.

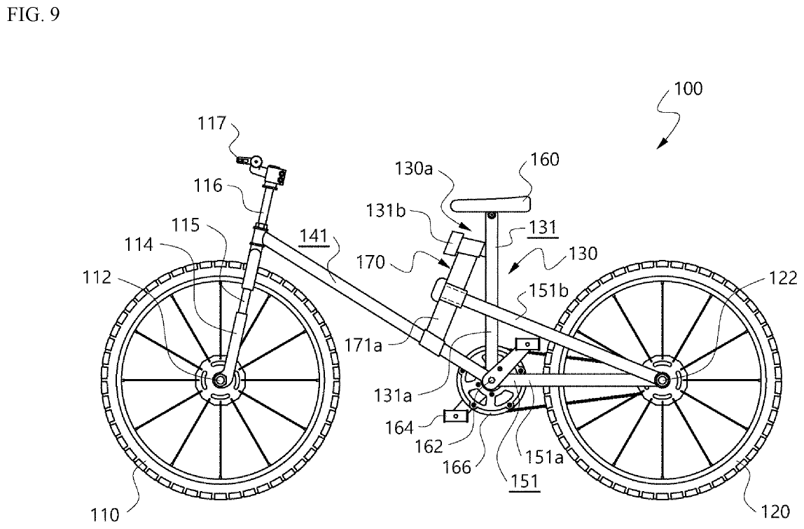

FIGS. 7 to 9 are side views respectively illustrating other modified examples of a two-wheeled vehicle according to the present invention.

In some cases, a rubber elastic body 171a bent convexly forward may be fixedly installed as a shock absorber 170 between the first front extension part 131b and the front wheel frame 141, and the rubber elastic body 171a may be connected to the second front extension part 151b, so that the saddle frame 131, the front wheel frame 141, and the rear wheel frame 151 are elastically supported by one rubber elastic body 171a.

In some cases, as shown in FIG. 8, the rubber elastic body 171a bent convexly backward may be installed between the first front extension part 131b and the front wheel frame 141, and the rubber elastic body 171a may be connected to the second front extension part 151b such that the rubber elastic body 171a can move forward and backward along the first front extension part 131b and the front wheel frame 141. The direction in which the rubber elastic body 171a is bent may be changed, and the shape of the rubber elastic body 171a may also be changed to other shapes, such as a straight line, a circle, and a square, a oval, and the like.

In some cases, as shown in FIG. 9, the forks 114 may be configured as a suspension fork on which a shock-absorbing means 115 is installed, as in the conventional art, such that the front wheel frame 141, the first front extension part 131b, and the second front extension part 151b are connected to each other by the rubber elastic body 171a while the first front extension part 131b is not connected to the handle shaft 116, etc.

In this case, the handle shaft 116 may be directly connected to the upper end of the forks 114. Here, the handle shaft 116 may serve as the fork shaft in the previous embodiment, and the front wheel frame 141 may be connected to the handle shaft 116.

Both ends of the rubber elastic body 171a may be coupled to the saddle frame 131 and the front wheel frame 141, respectively, and the second front extension part 151b of the rear wheel frame 151 may be connected to the middle portion of the rubber elastic body 171a, and accordingly, one rubber elastic body 171a may enable the saddle frame 131, the front wheel frame 141, and the rear wheel frame 151 to be elastically supported by each other. A straight line-shape rubber elastic body as shown in FIG. 9 may be used as the rubber elastic body 171a.

In the present invention, not only artificial rubber, such as silicone rubber, polyurethane, or elastomer, but also natural rubber may be used as the rubber elastic body 171a.

As noted from FIGS. 7 to 9, the rubber elastic body 171a may have various shapes.

The rest may be the same as described above.

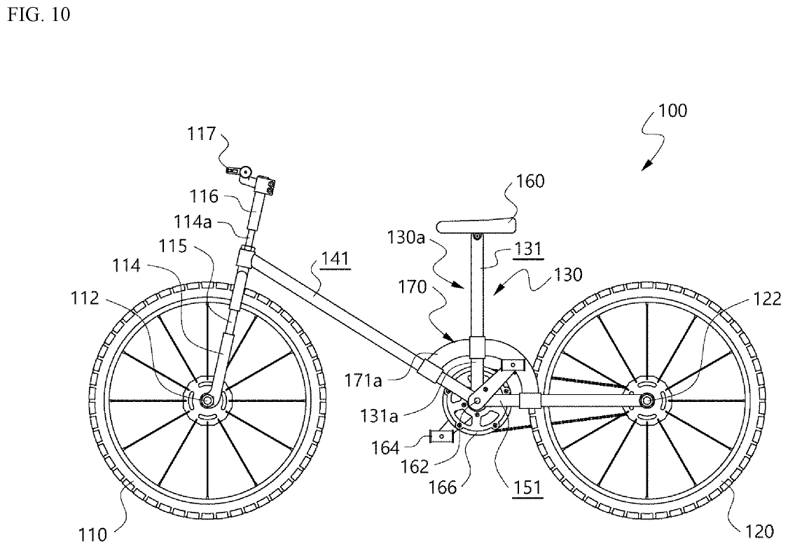

FIG. 10 is a side view illustrating another example of a two-wheeled vehicle according to the present invention.

In some cases, the two-wheeled vehicle 100 according to the present invention may further include the shock-absorbing means 115 installed on the forks 114 as known previously. In this case, as shown in FIG. 10, the saddle frame 131, the rear wheel frame 151 without the first and second extension parts described above, and the front wheel frame 141 may be rotatably connected to each other through the rotary support part 162, and the rubber elastic body 171a, preferably arc-shaped rubber elastic body 171a, may be installed to perform elastic support between the front wheel frame 141 and the saddle frame 131 and between the saddle frame 131 and the rear wheel frame 151.

The rest is the same as described with reference to FIG. 9.

When the two-wheeled vehicle 100 is configured using the vehicle body 130 for a two-wheeled vehicle as described above, the structure of the vehicle body 130 for a two-wheeled vehicle and the configuration of the shock absorber 170 can be simplified. In addition, the number of the shock absorber 170 to be installed can be reduced and the shock applied to the front wheel 110 and the rear wheel 120 and transmitted to the saddle can be buffered. Preferably, all the shocks applied to the front wheel 110 and the rear wheel 120 can be buffered by one shock absorber.

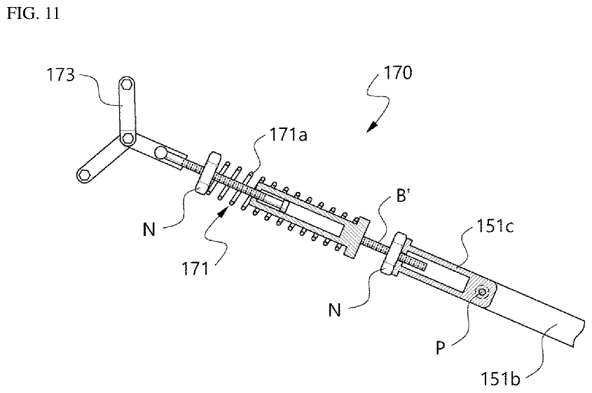

FIG. 11 illustrates a modified example of a shock absorber illustrated in FIG. 1. The example will be described with reference to FIG. 1 together.

In some cases, the shock-absorbing device 171 of the shock absorber 170 may include a telescopic bolt (B′) coupled to be stretchable and having threads formed on the outer circumferential surfaces of both ends thereof, at least one pair of nuts (N) coupled to the threads on the outer circumferential surfaces of the both ends, respectively, and a spring 171a coupled to the outer circumferential surfaces of the telescopic bolt (B′) between the pair of nuts (N), the spring 171a having a degree of compression adjustable according to the rotational direction of the at least one nut (N). One end of the telescopic bolt (B′) is rotatably connected to the foldable link 173, and the other end of the telescopic bolt (B′) is connected to the second front extension part 151b through a hollow member 151C. The connection direction of the shock absorber 171 may be reversed from that shown in FIG. 11.

The telescopic bolt (B′) may be configured by coupling a first member having a hollow portion formed therein and a thread formed at one end thereof to a second member having a head portion that is inserted into the hollow portion to be moveable along the hollow portion and a thread formed on the outer circumferential surface thereof, thereby being stretchable through the hollow portion and the head portion. In this case, as shown in FIG. 11, it is preferable to form a locking protrusion on the first member through which one end of the spring 171a can be caught, but the one end of the spring 171a may also be caught by the nut (N) without the locking protrusion.

When the shock absorber 170 shown in FIG. 11 is used, the magnitude of the elastic force of the spring 171a and the height of the saddle 160 may be appropriately adjusted to suit the user's physical condition by fastening or loosening the nut (N) on the side of the foldable link 173 and the nut (N) on the side of the second front extension part 151b. The nut (N) on the side of the foldable link 173 mainly serves to adjust a degree of compression of the spring 171a, and the nut (N) on the side of the second front extension part 151b serves to adjust a degree of compression of the spring 171a while adjusting the length of the shock-absorbing device 171. When the length of the shock-absorbing device 171 installed between the second front extension part 151b and the foldable link 173 is long, the front wheel frame 141 and the rotary connection part 151a of the rear wheel frame 151 receives a force so as to be unfolded around the rotary support part 162, and the saddle 160 and the saddle frame 131 connected to the rotary support part 162 rise accordingly. On the other hand, when the length of the shock-absorbing device 171 installed between the second front extension part 151b and the foldable link 173 is relatively short, the saddle 160 is lowered.

The rest is the same as described with reference to FIG. 1.

### INDUSTRIAL APPLICABILITY

The present invention may be applicable for manufacturing a two-wheeled vehicle such as a bicycle, a motorcycle, and the like.

1. A vehicle body for a two-wheeled vehicle, installed between a front wheel shaft of a front wheel and a rear wheel shaft of a rear wheel, the vehicle body comprising:
a rotary frame comprising a saddle frame having an upper end on which a saddle is mounted, a front wheel frame connected to the front wheel shaft, and a rear wheel frame connected to the rear wheel shaft, which are rotatably coupled to each other through a rotary support part; and
a shock absorber installed between the saddle frame, the front wheel frame, and the rear wheel frame, and configured to elastically support the front wheel frame and the rear wheel frame, which upwardly rotate toward the saddle frame around the rotary support part, with respect to the saddle frame,
whereby the single shock absorber is configured to be able to absorb all the shocks applied to the front wheel and the rear wheel.

2. The vehicle body for a two-wheeled vehicle of claim 1, wherein the saddle frame has a load support part having an upper end provided with a saddle mounting part on which the saddle is mounted and a lower end coupled to the rotary support part, and a first front extension part extending forward between the upper and lower ends of the load support part to be coupled to a protrusion or a handle shaft installed on a handle,
the front wheel frame extends forward from the rotary support part to be inclined upward so as to be coupled to a fork shaft of a fork installed on the front wheel shaft,
the rear wheel frame is provided with a rotary connection part extending rearward from the rotary support part to be connected to the rear wheel shaft, and a second front extension part extending forward from the rotary connection part to be inclined upward,
the handle shaft, which is prohibited from moving up and down and is supported to be rotatable left and right with respect to the first front extension part, is connected to the fork shaft such that the fork shaft is not allowed to rotate left and right and is allowed to move up and down around the rotary support part, and
the shock absorber is installed between the first front extension part, the second front extension part, and the front wheel frame.

3. The vehicle body for a two-wheeled vehicle of claim 2, wherein the shock absorber comprises:
a shock-absorbing device installed on the second front extension part to face forward; and
a foldable link connected to the front end of the shock-absorbing device and connected to the first front extension part and the front wheel frame, respectively, to be bent rearward so as to be unfolded or folded according to the magnitude of a force acting on the shock-absorbing device, thereby performing elastic support between the first front extension part and the front wheel frame.

4. The vehicle body for a two-wheeled vehicle of claim 3, wherein the shock-absorbing device is rotatably installed on the second front extension part.

5. The vehicle body for a two-wheeled vehicle of claim 3, wherein the shock-absorbing device is connected to the second front extension part or the foldable link through a bolt and a nut to adjust a degree of compression of the shock-absorbing device, thereby adjusting the magnitude of an elastic force for supporting the foldable link.

6. The vehicle body for a two-wheeled vehicle of claim 2, wherein the shock absorber comprises:
a shock-absorbing device installed on the second front extension part to face forward; and
a foldable link connected to the front end of the shock-absorbing device and connected to the first front extension part and the front wheel frame, respectively, to be bent rearward so as to be unfolded or folded according to the magnitude of a force acting on the shock-absorbing device, thereby performing elastic support between the first front extension part and the front wheel frame,
wherein the shock-absorbing device comprises:
a telescopic bolt coupled to be stretchable and having threads formed on the outer circumferential surfaces of both ends thereof;
at least one pair of nuts coupled to the threads on the outer circumferential surfaces of the both ends, respectively; and
a spring coupled to the outer circumferential surfaces of the telescopic bolt between the pair of nuts, the spring having a degree of compression adjustable according to the rotational direction of the at least one nut.

7. The vehicle body for a two-wheeled vehicle of claim 1, wherein the rotary support part comprises a driving shaft, the front wheel frame, the rear wheel frame, and the saddle frame are connected to be rotatable with respect to the driving shaft, and the driving shaft is rotatably driven by one of pedals, a prime mover, and a motor.

8. The vehicle body for a two-wheeled vehicle of claim 2, wherein the shock absorber comprises a rubber elastic body installed between the first front extension part, the front wheel frame, and the second front extension part.

9. The vehicle body for a two-wheeled vehicle of claim 1, wherein the shock absorber comprises one of a coil spring, a rubber elastic body, a hydraulic cylinder mechanism, and a pneumatic cylinder mechanism.

10. A shock absorber comprising:
a shock-absorbing device; and
a foldable link connected to one end of the shock-absorbing device,
wherein the foldable link is unfolded or folded according to the magnitude of an elastic force received from the shock-absorbing device due to a force applied to the shock-absorbing device from a first member connected to the other end of the shock-absorbing device, thereby performing elastic support between a second member and a third member which are rotatably connected to both ends of the foldable link, respectively.

11. The shock absorber of claim 10, wherein the shock-absorbing device comprises:
a telescopic bolt coupled to be stretchable and having threads formed on the outer circumferential surfaces of both ends thereof;
at least one pair of nuts coupled to the threads on the outer circumferential surfaces of the both ends, respectively; and
a spring coupled to the outer circumferential surfaces of the telescopic bolt between the pair of nuts, the spring having a degree of compression adjustable according to the rotational direction of the at least one nut.

12. A two-wheeled vehicle comprising:
a front wheel;
a rear wheel; and
the vehicle body for a two-wheeled vehicle according to claim 1 installed between a front wheel shaft of the front wheel and a rear wheel shaft of the rear wheel.

13. A two-wheeled vehicle comprising:
a front wheel;
a rear wheel; and
the vehicle body for a two-wheeled vehicle according to claim 2 installed between a front wheel shaft of the front wheel and a rear wheel shaft of the rear wheel.

14. A two-wheeled vehicle comprising:
a front wheel;
a rear wheel; and
the vehicle body for a two-wheeled vehicle according to claim 3 installed between a front wheel shaft of the front wheel and a rear wheel shaft of the rear wheel.

15. A two-wheeled vehicle comprising:
a front wheel;
a rear wheel; and
the vehicle body for a two-wheeled vehicle according to claim 4 installed between a front wheel shaft of the front wheel and a rear wheel shaft of the rear wheel.

16. A two-wheeled vehicle comprising:
a front wheel;
a rear wheel; and
the vehicle body for a two-wheeled vehicle according to claim 5 installed between a front wheel shaft of the front wheel and a rear wheel shaft of the rear wheel.

17. A two-wheeled vehicle comprising:
a front wheel;
a rear wheel; and
the vehicle body for a two-wheeled vehicle according to claim 6 installed between a front wheel shaft of the front wheel and a rear wheel shaft of the rear wheel.

18. A two-wheeled vehicle comprising:
a front wheel;
a rear wheel; and
the vehicle body for a two-wheeled vehicle according to claim 7 installed between a front wheel shaft of the front wheel and a rear wheel shaft of the rear wheel.

19. A two-wheeled vehicle comprising:
a front wheel;
a rear wheel; and
the vehicle body for a two-wheeled vehicle according to claim 8 installed between a front wheel shaft of the front wheel and a rear wheel shaft of the rear wheel.

20. A two-wheeled vehicle comprising:
a front wheel;
a rear wheel; and
the vehicle body for a two-wheeled vehicle according to claim 9 installed between a front wheel shaft of the front wheel and a rear wheel shaft of the rear wheel.
